(19) United States
(12) Patent Application Publication
(10) Pub. No.: US 2006/0254609 A1
(43) Pub. Date: Nov. 16, 2006

(54) Interdental brushes

(76) Inventor: Kung-Pao Kuo, Kaohsiung city (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,093

(22) Filed: May 10, 2005

(51) Int. Cl. A61C 15/00

(52) U.S. Cl. 132/321

(57) ABSTRACT

An interdental brush includes a plurality of interdental brushes and each interdental brush includes a handle and a brush portion connected to the handle. The handles are connected with each other side by side by connection plates which are easily torn apart so that the user can easily take one of the interdental brush from the assembly. The connected interdental brushes are received in a box which is conveniently opened to access the interdental brushes. After also the user uses then performs to discard, increases the easy to operate.

### FIELD OF THE INVENTION

The present invention relates to an interdental brush which is compact and easily to carry and can be manufactured at low manufacturing cost.

### BACKGROUND OF THE INVENTION

People contact with each other frequently in social activities and proper manners and skills are required. It is important to have good oral hygiene which is deemed as a good personal image so that oral hygiene gets more attention for everyone. However, mot of the people have lunches and/or dinners outside so that it is impossible to brush their teeth after every meal. Therefore, dental flosses and interdental brushes are used widely for cleaning teeth especially for cleaning gaps between teeth. The interdental brushes are not convenient to carry while go out for lunches or dinners and it is impossible for the users to brush their teeth in restaurants. Dental flosses occupy less space and can be put in pockets, but it can be used for removing residue in the gaps between the teeth and cannot be used to clean surfaces of teeth. FIG. 1 shows a conventional interdental brush 1 that includes a handle 11 and a brush portion 12 connected on the handle 11. A cap 13 is used to cover up the brush portion 12 to avoid from being contaminated. The users hold the handle 11 and insert the brush portion 12 into the gaps between teeth so as teeth to remove the food residue from the teeth. However, the conventional interdental brush 1 has a large handle 11 and each interdental brush 1 is equipped with a cap 13 so that the interdental brush 1 becomes too big to carry conveniently. Besides, due to that people have their meals outside so frequently, it needs three interdental brushes 1 for three times of use everyday and some people need more number of the interdental brushes 1 to be carried. This large number of individual interdental brushes 1 is not convenience for the users to carry. Furthermore, for the manufacturers, each interdental brush 1 is cooperated with a cap 13 which needs more costs. Therefore the whole manufacture step many consumes time, relatively creates the expense cost to enhance, reality not symbol economic efficiency.

The present invention intends to provide an interdental brush that are compact and are connected with each other by a small connection plate so that the users can easily carried.

### SUMMARY OF THE INVENTION

The present invention relates to an interdental assembly and comprises a plurality of interdental brushes received in a box and each interdental brush has a handle and a brush portion connected to the handle. The handles are connected with each other side by side by connection plates which are conveniently torn apart so that the interdental brushes can be picked individually.

The object of the present invention is to provide an interdental brush assembly that is easily to be manufactured and carried.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional interdental brush;

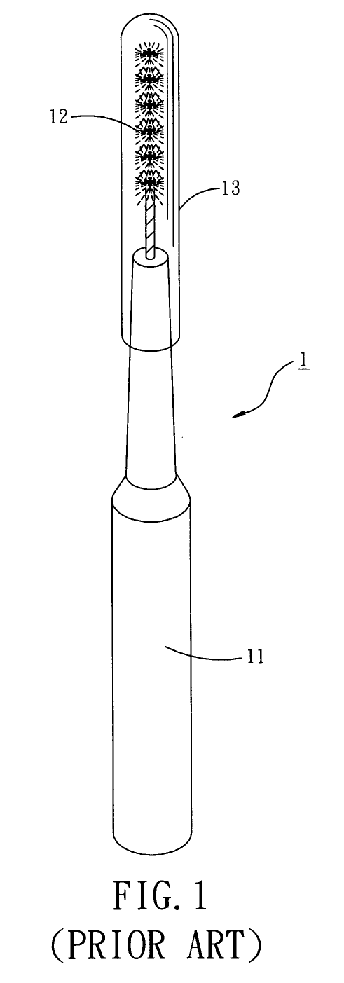

FIG. 2 shows the interdental brushes of the present invention connected with each other;

FIG. 3 is a cross sectional view to show that interdental brushes of the present invention are received in a box, and

FIG. 4 shows that the interdental brush can be separated from the assembly of the interdental brushes by tearing the connection plate apart.

### DETAILED DESCRIPTION OF THE PREFERRED EMBODIMENT

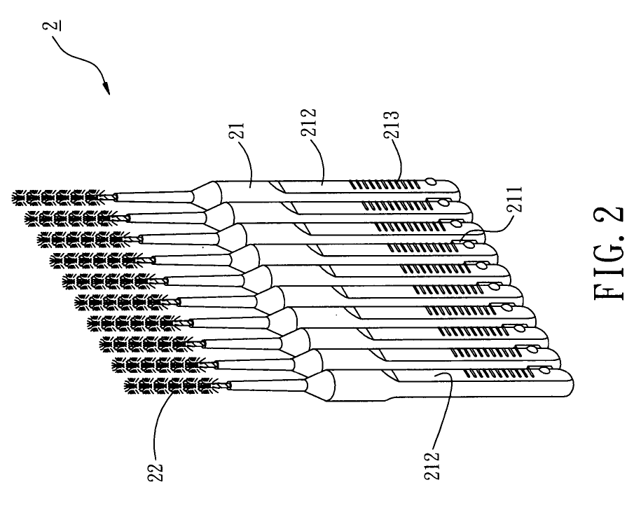

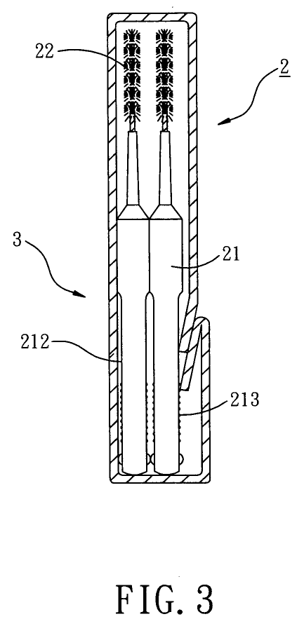

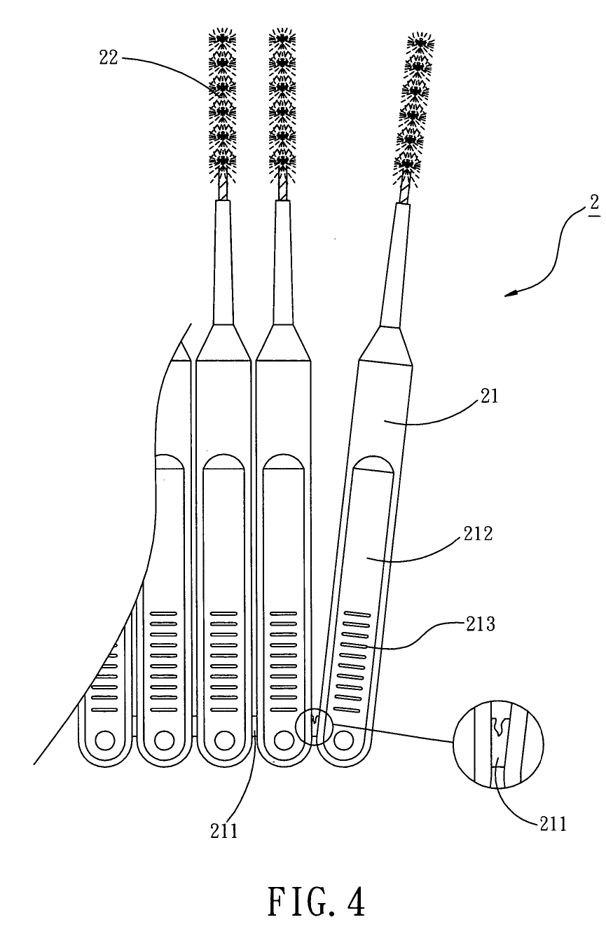

Referring to FIGS. 2 to 4, the interdental brushes assembly of the present invention comprises a plurality of interdental brushes 2 and each interdental brush 2 has a handle 21 and a brush portion 22 that is connected to an extension extending from an end of the handle 21. Each handle 21 includes two flat surfaces 212 on two opposite sides thereof so as to form a holding area and ridges 213 extend from an outer surface of the holing area. The ridges 213 are oriented to be perpendicular to a longitudinal axis of the handle 21 such that the user can easily hold the interdental brushes 2.

The handles 21 are connected with each other side by side by connection plates 211 and each connection plate 211 has a notch defined in a top edge thereof so that the user can conveniently tear the connection plate 211 apart to pick one of the interdental brushes 2.

A box 3 is provided to receive the connected interdental brushes 2 and the box 3 designed to be easily opened so that the user can pick one of the interdental brushes 2 easily. And the overall volume of interdental brush 2 changes slightly, in order to help collects to the box 3. It will be advantageous to carrying conveniently, simultaneously will consider the reality use demand. Therefore the compact size of the interdental brushes 2, each box 3 may receive two rows which are twenty interdental brushes 2 which are enough for a whole week of use for three interdental brushes 2 per day. The present invention has the following advantages:

(1) The interdental brushes are connected side by side by the connection plates so that they are well organized in the box and the connected interdental brushes occupy a small space and the box allows the user to put it in pockets.

(2) Each handle of the interdental brushes has a holding area for convenience of grasp and the connection plates allow the user to pick the interdental brushes one by one easily. The interdental brushes can be discarded after using the brush portion 22 to remove residue of food in the gaps between teeth. So as to achieve maintains the oral cavity the clean hygienic effect

(3) The interdental brushes can be produced in mass production by way of plastic injection so that only a low manufacturing cost is involved.

While we have shown and described the embodiment in accordance with the present invention, it should be clear to those skilled in the art that further embodiments may be made without departing from the scope of the present invention.

What is claimed is:

1. An interdental brush assembly comprising:
a plurality of interdental brushes and each interdentalinterdental brush having a handle and a brush portion connected to the handle, the handles connected with each other side by side by connection plates.

2. The assembly as claimed in claim 1, wherein each handle includes ridges extending from an outer surface thereof.

3. The assembly as claimed in claim 2, wherein each handle includes two flat surfaces defined in an outer surface thereof and the ridges extend from an outer surface of the flat surfaces.
